(19) United States
(12) Patent Application Publication
(10) Pub. No.: US 2008/0028210 A1
(43) Pub. Date: Jan. 31, 2008

(54) Packet cipher processor and method

(75) Inventor: Kazuya Asano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/878,249

(22) Filed: Jul. 23, 2007

(30) Foreign Application Priority Data
Jul. 31, 2006 (JP) 2006-207327

(51) Int. Cl. H04L 9/18

(52) U.S. Cl. 713/161

(57) ABSTRACT

A packet cipher processor and method for realizing fast packet cipher processing. A packet identification unit analyzes a received target packet to identify an applicable policy to the target packet. Then the packet identification unit creates and gives policy information of the identified policy together with the target packet to a header processing unit. The header processing unit converts the header of the target packet according to the policy information and passes the processing of the target packet to a cipher unit. The cipher unit performs a prescribed cipher process according to the policy on the target packet with the converted header, and outputs the ciphered packet. The packet identification unit, the header processing unit, and the cipher unit operate independently to perform the above processes in a pipeline manner.

### CROSS-REFERENCE TO RELATED APPLICATIONS

This application is based upon and claims the benefits of priority from the prior Japanese Patent Application No. 2006-20732, filed on Jul. 31, 2006, the entire contents of which are incorporated herein by reference.

### BACKGROUND OF THE INVENTION

(1) Field of the Invention

It is related to a packet cipher processor and method, and particularly to a packet cipher processor and method for performing prescribed cipher processing on received packets and outputting the ciphered packets.

(2) Description of the Related Art

Today, the Internet is very useful to exchange various kinds of information. At the same time, however, it should be noticed that communication over the Internet has risks of tapping or falsifying the contents of communication. For this reason, encryption and authentication are necessary to protect highly confidential information that is transmitted over the Internet. Not only for communication over the public Internet but also for communication using a closed network or Local Area Network (LAN) that can be accessed by specified users only, the encryption and the authentication are often performed in order to prevent leakage.

A conventional packet encryption apparatus that performs encryption and authentication will be described with reference to FIG. 14.

The conventional packet encryption apparatus has a Central Processing Unit (CPU) 91 for processing packets as well as controlling overall processing, a memory 92 for temporarily storing data including packets, an encryption/authentication accelerator 93 for performing encryption and authentication, and external interfaces (I/F) 94 and 95 for receiving/outputting communication packets.

In the case where such packet encryption apparatus composes a Virtual Private Network (VPN), for example, packets are encrypted by the following steps:

(1) An identification step of determining what policy is used to process a received packet. In this connection, the policy defines encryption/authentication algorithms, encryption/authentication keys, and so on.

(2) A header processing step of adding or converting a header according to the identified policy.

(3) An encryption and authentication step of performing encryption and authentication on data to be protected, according to the identified policy.

For steps (1) and (2) out of the above steps, procedures may be difficult to be standardized because a user may set a unique policy, and therefore the CPU 91 runs software programs to realize the steps. For step (3), the encryption/authentication accelerator 93 that is dedicated to calculate encryption/authentication algorithms is often used in these days. Using the encryption/authentication accelerator 93 results in fast encryption and authentication processes. In inexpensive devices, however, step (3), as well as steps (1) and (2), may be realized by the CPU 91.

In such packet encryption apparatus, the CPU 91 executes the identification step and the header processing step in time series. Then the CPU 91 gives the processed packet to the dedicated encryption/authentication accelerator 93 which then executes fast encryption, thereby obtaining improved throughput.

Further, in order to improve throughput of the encryption and authentication processes, there has been proposed a security communication packet processor that performs encryption and authentication in parallel by dividing a packet into prescribed data blocks, sequentially inputting the data blocks to an encryption unit on a data block basis, and sequentially giving the processed data blocks to a subsequent authentication unit (for example, refer to Japanese Unexamined Patent Application Publication No. 2002-287620, paragraphs [0016] to [0024] and FIG. 1).

The conventional packet encryption apparatus, however, has a drawback in that throughput cannot be improved because a CPU that controls overall processing also performs software processing and the software processing becomes a bottleneck.

For example, it may be considered that the fast encryption/authentication accelerator 93 is provided in the above-mentioned packet encryption apparatus in order to realize faster encryption and authentication processes and thereby improve overall throughput. This technique is effective for the case where packet length is long and therefore the encryption/authentication accelerator 93 takes a large part of the entire encryption processing.

On the other hand, for the identification process that is executed by running software, a reference table containing identification information and policies in association with each other is previously prepared, for example, and the reference table is searched to extract a relevant policy. If the reference table contains a lot of data, the identification process cannot be performed on packets without delay. Further, in the packet processing, a tunnel header, an IP Security Protocol (IPSEC) Encapsulating Security Payload (ESP) header, or an Authentication Header (AH) is added. This addition process may produce considerable loads if packet length is short, due to overhead caused by memory access and header field manuplation.

The identification process and the packet processing need some processing time, irrespective of packet length. Therefore, if packet length is short, the identification process and header processing occupy a relatively large part of the entire packet encryption processing.

FIG. 15 is a sequence of the encryption processing that is performed by the conventional packet encryption apparatus.

When the conventional packet encryption apparatus receives a packet 1, the CPU 91 executes an identification step 96a and a header processing step 96b of the packet 1, and gives the processed data to the encryption/authentication accelerator 93 where an encryption step 96c is executed.

As to a packet 2 that comes after the packet 1, the processing of the packet 2 is always started after the processing of the packet 1 is completed. This is because the CPU 91 that controls the overall processing performs the first process. Specifically, after the processing of the packet 1 is completed and the CPU 91 becomes available, an identification step 97a, a header processing step 97b, and an encryption step 97c are executed for the packet 2. In short, processing of a next packet is not started until processing of a current packet is completed. As a result, in the case where packet length is short, that is, in the case where the identification step and the header processing step have relatively high overhead, even if the encryption step can be executed fast, the relatively high overhead becomes a bottleneck and final throughput cannot be improved.

Conventionally, it is not rare that an encryption/authentication accelerator produces much smaller throughput than its own capacity.

### SUMMARY OF THE INVENTION

In view of foregoing and intends, a packet cipher processor and method for eliminating bottlenecks to thereby speed up packet cipher processing are provided.

To accomplish the above problem, there is provided a packet cipher processor for performing prescribed cipher processing on a received packet and outputting the packet. This packet cipher processor comprises: a packet identification unit for analyzing a received target packet to be processed, to identify a policy applicable to the target packet, and creating policy information of the policy; a header processing unit for converting according to the policy information the header of the target packet, which has been subjected to the identification process by the packet identification unit; and a cipher unit for performing a prescribed cipher process including at least one of encryption, decryption, and authentication, according to the policy information, on the target packet and outputting the target packet, wherein the packet identification unit, the header processing unit and the cipher unit operate independently.

Further, to accomplish the above problem, there is provided a packet cipher method for performing prescribed cipher processing on a received packet and outputting the packet. This packet cipher method comprises: a packet identification step of analyzing a received target packet to be processed, to identify a policy applicable to the target packet, and creating policy information of the policy; a header processing step of converting according to the policy information the header of the target packet, which has been processed at the packet identification step; and a cipher step of performing a prescribed cipher process including at least one of encryption, decryption, and authentication, according to the policy information, on the target packet and outputting the target packet, wherein the packet identification step, the header processing step and the cipher step are executed independently.

The above and other objects, features and advantages will become apparent from the following description when taken in conjunction with the accompanying drawings which illustrate preferred embodiments by way of example.

### BRIEF DESCRIPTION OF THE DRAWINGS

FIG. 1 is a concept that is implemented in one embodiment.

FIG. 2 is a sequence of packet processing of a packet cipher processor.

FIG. 3 shows an example system configuration according to one embodiment.

FIG. 4 shows an internal configuration of a VPN device according to one embodiment.

FIG. 5 shows an internal configuration of an identification module according to one embodiment.

FIG. 6 shows an example of implementation of an identification module comprising optimized cores, according to one embodiment.

FIG. 7 shows an example structure of data to be given from an identification module to a header processing module, according to one embodiment.

FIG. 8 shows an internal configuration of a header processing module according to one embodiment.

FIG. 9 shows an example of implementation of a header processing module comprising an optimized core, according to one embodiment.

FIG. 10 shows an example structure of data to be given from a header processing module to a cipher module, according to one embodiment.

FIG. 11 shows an internal configuration of a cipher module according to one embodiment.

FIG. 12 shows an example of implementation of a cipher module comprising an optimized core, according to one embodiment.

FIG. 13 shows an example of a VPN device according to the second embodiment.

FIG. 14 shows the configuration of conventional packet encryption apparatus.

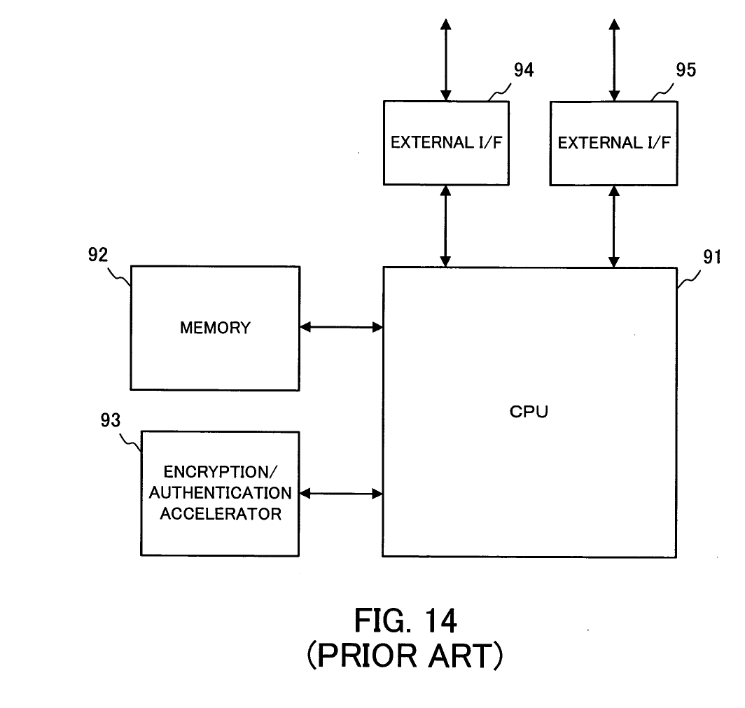

FIG. 15 is a sequence of encryption processing that is performed by the conventional packet encryption apparatus.

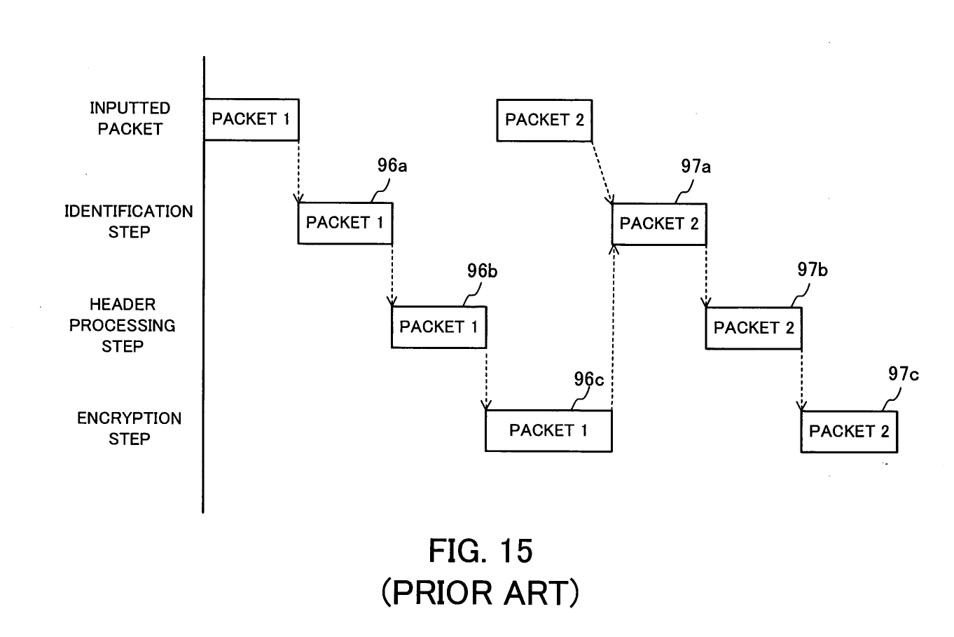

### DESCRIPTION OF THE PREFERRED EMBODIMENTS

Preferred embodiments will be described with reference to the accompanying drawings. The concept that is implemented in one embodiment will be first described and then the embodiments will be described in detail.

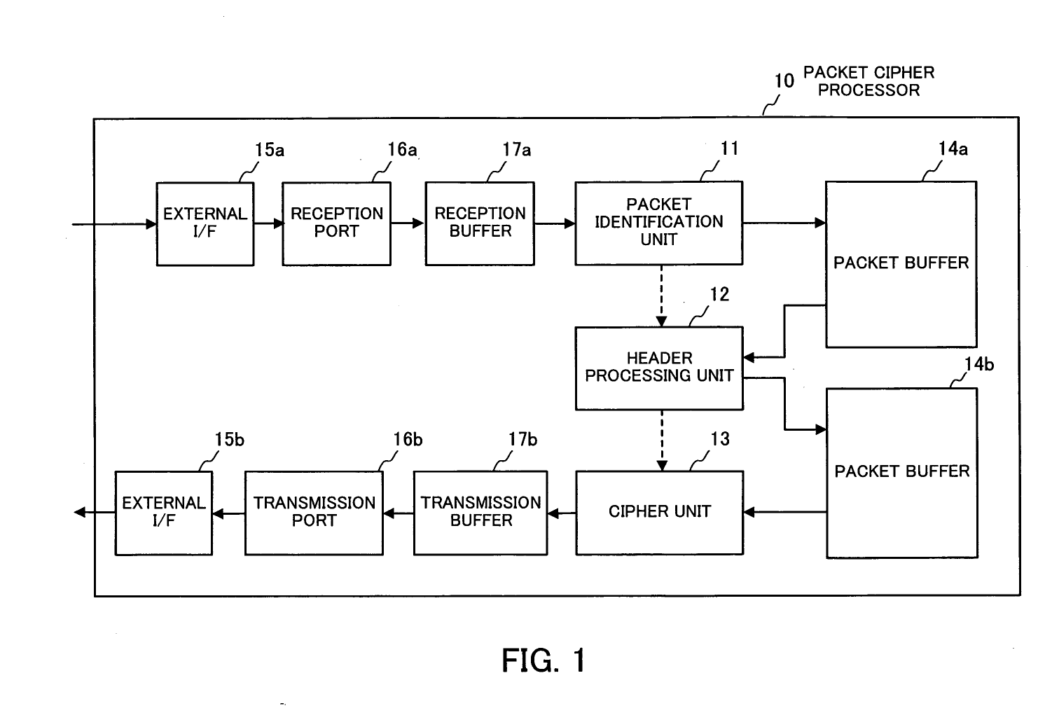

FIG. 1 shows a concept that is implemented in one embodiment. Arrows indicate a flow of data and dotted arrows indicate steps of packet cipher processing.

A packet cipher processor 10 has a packet identification unit 11 for identifying a policy from a packet, a header processing unit 12 for converting the header of the packet according to the policy, a cipher unit 13 for performing a prescribed cipher process according to the policy, packet buffers 14a and 14b for temporarily storing transition information between the processing units, external interfaces (I/F) 15a and 15b, a reception port 16a, a transmission port 16b, a reception buffer 17a, and a transmission buffer 17b.

The external I/F 15a is connected to a prescribed communication circuit, and a packet inputted via the external I/F 15a is stored in the reception buffer 17a via the specified reception port 16a.

On the other hand, a packet stored in the transmission buffer 17b is transmitted via the specified transmission port 16b from the external I/F 15b that is connected to a prescribed communication circuit.

The packet identification unit 11 reads a target packet stored in the reception buffer 17a, and analyzes the target packet to identify an applicable policy. The packet identification unit 11 stores a reference table containing reference data to be used for identifying inputted packets, such as destination addresses and source addresses. Upon reception of a packet, the packet identification unit 11 compares data of the packet with the reference table to determine an applicable policy. For this process, by using a packet identification method disclosed in Japanese Patent Application No. 2004-567524 filed by the applicant of this application, a fast packet identification process can be realized. It should be noted that the packet identification method is not limited to this, and another method can be employed, provided that a required processing speed can be realized. In addition, not only the packet identification but also packet analysis is performed to determine where a header is added to or removed from or which part of the header should be modified. Since the comparison process that is performed in the packet identification includes the header analysis, header analysis that is required in the header conversion process can be omitted, which does not produce an extra load. The obtained analysis result is written in the packet buffer 14a and then given to the header processing unit 12, together with the target packet and the policy information as transition information. The packet identification unit 11 is then capable of processing a next packet.

The header processing unit 12 reads the target packet and the transition information, which was stored in the packet buffer 14a by the packet identification unit 11, and converts the header of the target packet according to the policy information and the header analysis information included in the transition information. The header processing includes addition/removal and conversion of various headers according to a policy. The processed target data is written in the packet buffer 14b and then given to the cipher unit 13, together with the policy information. The header processing unit 12 is then capable of processing a next packet.

The cipher unit 13 reads the target packet, the policy information and so on, which were stored in the packet buffer 14b by the header processing unit 12, and performs a prescribed cipher process including at least one of encryption, decryption, and authentication on the target packet according to the policy information. That is, if it is determined based on the policy information that only encryption is necessary, only the encryption is performed. If it is determined that the packet requires both decryption and authentication, both processes are performed. The ciphered target packet is stored in the transmission buffer 17b. The cipher unit 13 is then capable of processing a next packet.

The packet buffers 14a and 14b are memories to be used in the processing steps, and stores therein target packets and information such as policy information and header analysis information. The packet buffer 14a for storing data to be passed from the packet identification unit 11 to the header processing unit 12 and the packet buffer 14b for storing data to be passed from the header processing unit 12 to the cipher unit 13 may be provided separately, or one buffer may be shared by the packet identification unit 11, the header processing unit 12, and the cipher unit 13. In the case of sharing one buffer, access control among the packet identification unit 11, the header processing unit 12 and the cipher unit 13 should be performed.

The operation of the packet cipher processor 10 having the above configuration and the packet cipher method will now be described. The following describes a case where the packet cipher processor 10 is a processor for encryption. For decryption, only parameters to be used in the identification process are different and the basic operation is the same.

To the packet cipher processor 10, a prescribed packet is inputted via the external I/F 15a and the reception port 16a, and is stored in the reception buffer 17a. The packet identification unit 11 analyzes the target packet stored in the reception buffer 17a to compare the contents of the packet to the reference table, in order to thereby determine an applicable policy to the target packet. Then the packet identification unit 11 creates policy information of the determined policy and stores it in the packet buffer 14a together with the target packet. At this time, the header of the packet is also analyzed and the header analysis information is stored in the packet buffer 14a. After the processing is passed to the header processing unit 12, the packet identification unit 11 is capable of starting to process a next packet. The header processing unit 12 converts the header of the target packet according to the policy information. The target packet with the converted header is stored in the packet buffer 14b together with the policy information. The cipher unit 13 performs a cipher process according to the policy, and if necessary, performs the authentication process.

The packet identification unit 11, the header processing unit 12, and the cipher unit 13 operate independently. Specifically, while the packet identification unit 11 performs the identification process on a packet, the header processing unit 12 processes the header of a packet which has been already subjected to the identification process. In addition, at the same time, the cipher unit 13 performs the cipher/authentication processes on another packet which has been processed by the header processing unit 12.

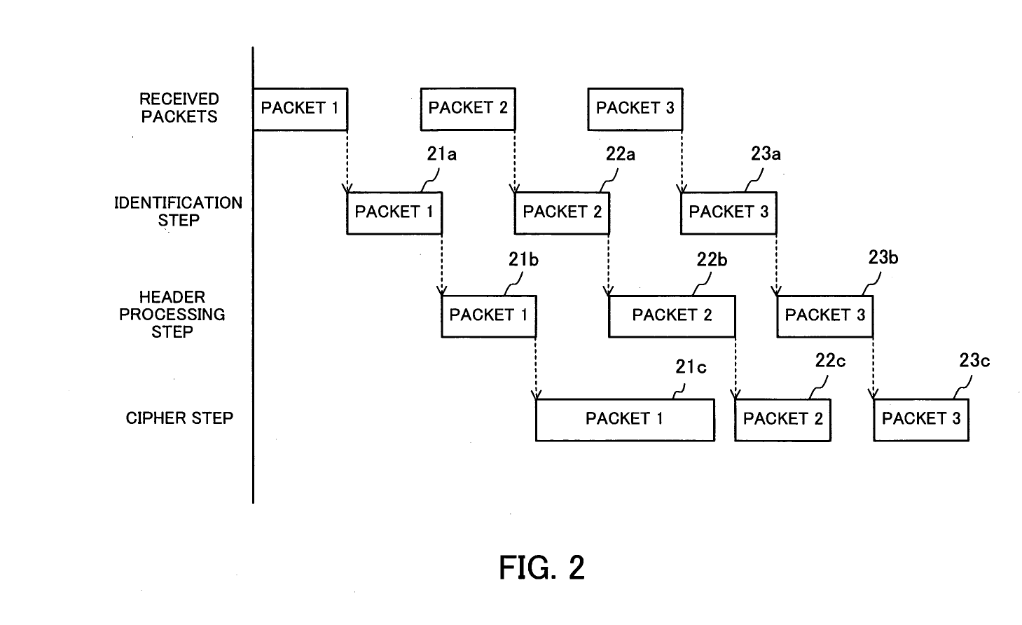

FIG. 2 is a sequence of the packet processing steps of the packet cipher processor according to this invention.

When a packet 1 is inputted to the packet cipher processor 10, the packet identification unit 11 executes an identification step 21a of the packet 1, and passes the processing to the header processing unit 12. The header processing unit 12 executes a header processing step 21b of the packet 1, and passes the processing to the cipher unit 13. The cipher unit 13 executes a cipher step 21c and then the encryption processing of the packet 1 is completed.

The packet identification unit 11, the header processing unit 12, and the cipher unit 13 operate independently. Therefore, the packet identification unit 11, the header processing unit 12, and the cipher unit 13 perform different processes on different packets at the same time. Referring to the example of FIG. 2, when the packet identification unit 11 completes the identification step 21a of the packet 1, it starts an identification step 22a of a packet 2 inputted next. At this time, the header processing unit 12 executes the header processing step 21b of the packet 1. Then when the header processing unit 12 completes the header processing step 21b of the packet 1, the cipher unit 13 starts the cipher step 21c. While the cipher unit 13 executes the cipher step 21c of the packet 1, the packet identification unit 11 completes an identification step 22a of the packet 2 and then the header processing unit 12 starts a header processing step 22b. Since the packet identification unit 11 completed the identification step 22a of the packet 2, it starts an identification step 23a of a packet 3 inputted next. At this time, the header processing unit 12 executes the header processing step 22b of the packet 2 and the cipher unit 13 executes the cipher step 21c of the packet 1. After that, if the header processing unit 12 completes the header processing step 22b of the packet 2 and the identification step 23a of the packet 3 is also completed, the header processing unit 12 starts to execute the header processing step 23b of the packet 3. Similarly, if the cipher unit 13 completes the cipher step 21c of the packet 1 and the header processing step 22b of the packet 2 is also completed, the cipher unit 13 executes the cipher step 22c of the packet 2, and if this step 22c is completed and the header processing step 23b of the packet 3 is also completed, the cipher unit 13 starts to execute a cipher step 23c of the packet 3. As to the packet identification unit 11, if an identification step is completed and a next packet is inputted, the packet identification unit 11 starts to execute an identification step of the next packet.

As described above, in the packet cipher processor 10 according to this invention, the packet identification unit 11, the header processing unit 12, and the cipher unit 13, which operate independently, execute the identification step, the header processing step, and the cipher step in a pipeline manner. This can realize faster packet cipher processing. Especially, faster packet cipher processing can be realized in the case where a packet of short packet length is processed and therefore the identification step and the header processing step for such a packet occupy a relatively large part of the entire processing.

In this connection, in the above description, after the header processing unit 12 completes header conversion, the cipher unit 13 starts the encryption process. However, the order of the processes is not fixed and the processing order can be changed.

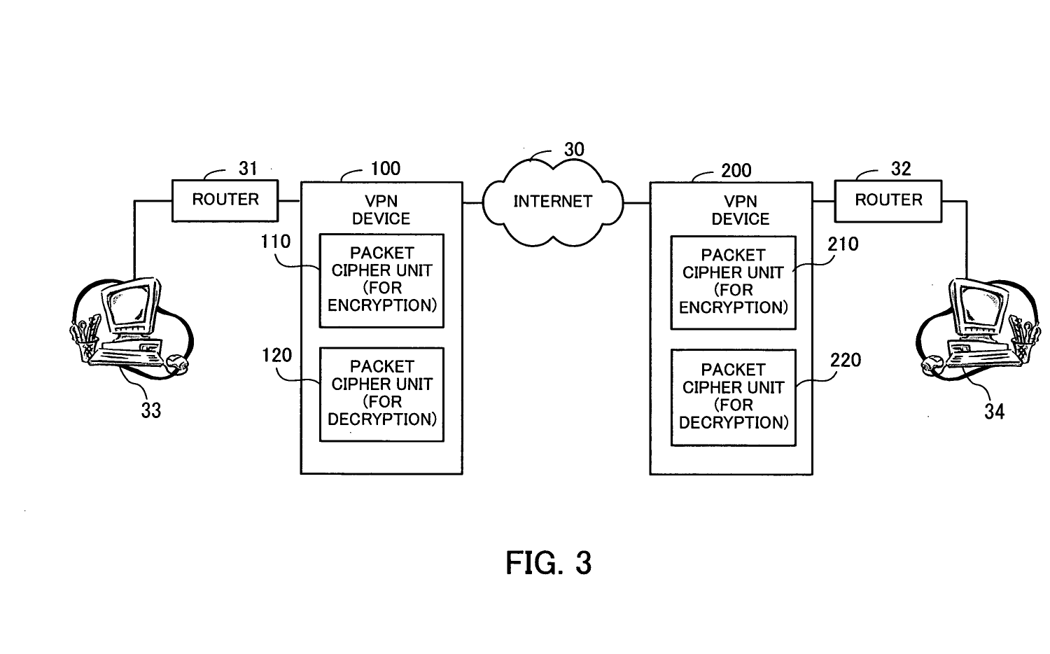

Now, a case of applying the embodiment to a VPN device on the Internet will be described in detail with reference to FIG. 3.

FIG. 3 shows an example system configuration according to the embodiment of this invention.

In this embodiment of this invention, in a VPN device 100, a packet cipher unit 110 for encryption and a packet cipher unit 120 for decryption are incorporated. Similarly, in a VPN device 200, a packet cipher unit 210 for encryption and a packet cipher unit 220 for decryption 220 are incorporated. In the packet cipher units 110, 120, 210, and 220, the processing functions of the packet cipher processor shown in FIG. 1 are incorporated.

Each VPN device 100, 200 has an interface for LAN and an interface for the Internet 30, and they are connected to each other over the Internet 30. The VPN device 100 is connected to a terminal device 33 via a router 31. The VPN device 200 is connected to a terminal device 34 via a router 32. The VPN device 100, 200 encrypts a packet to be transmitted from the terminal device 33, 34 to the Internet 30, and decrypts an encrypted packet received from the Internet 30 and transfers it to the terminal device 33, 34.

In the example of FIG. 3, the VPN device 100, 200 and the router 31, 32 are separate devices, but may be integrated into one device.

For simple explanation, a packet authentication process will be omitted, but the authentication function can be easily added.

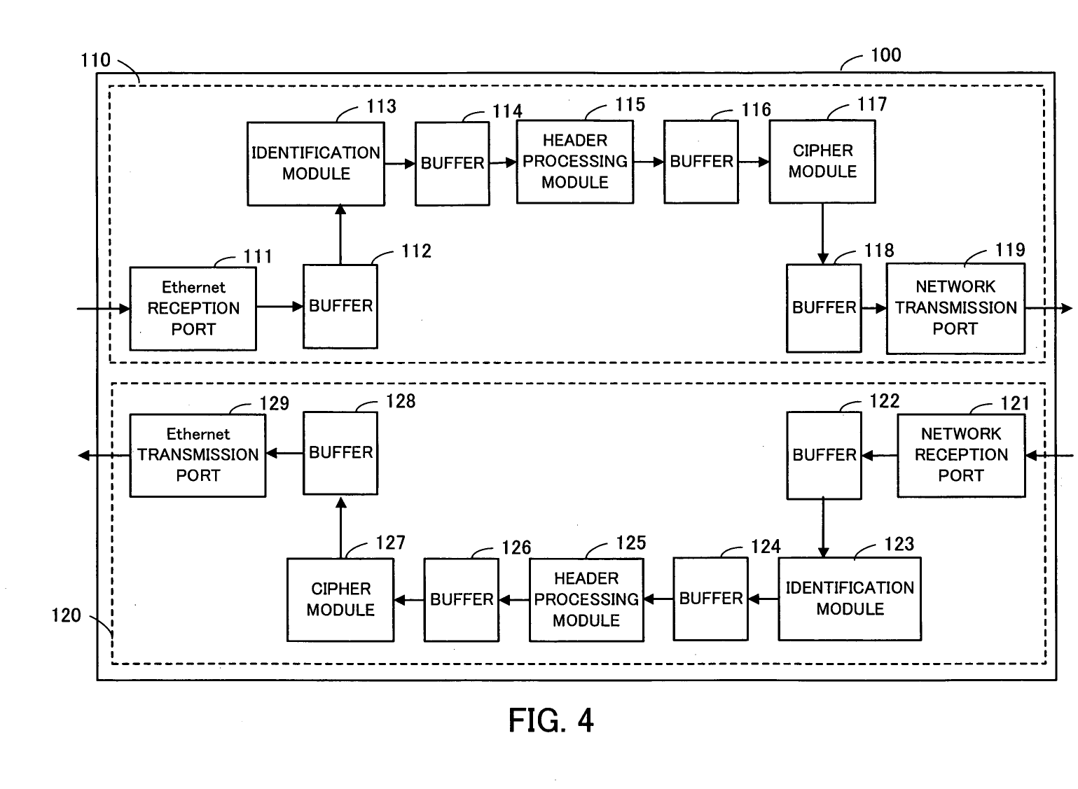

FIG. 4 shows an internal configuration of a VPN device according to the embodiment of this invention. FIG. 4 shows the configuration of the VPN device 100, and the VPN device 200 have the same internal configuration.

The VPN device 100 has the packet cipher unit 110 for encrypting a packet received from LAN and transmitting the encrypted packet to the Internet 30, and the packet cipher unit 120 for decrypting a packet received from the Internet 30 and transmitting the decrypted packet to the LAN.

The packet cipher unit 110 for encryption has an Ethernet (trademark) reception port 111, a buffer 112, an identification module 113, a buffer 114, a header processing module 115, a buffer 116, a cipher module 117, a buffer 118, and a network transmission port 119, and is designed to encrypt a packet received from the router 31 and transmits the encrypted packet to the Internet 30.

The Ethernet reception port 111 is connected to the Ethernet, and is designed to give packets received via the Ethernet, to a packet reception circuit (not illustrated). The packet reception circuit receives the packets from the Ethernet reception port 111 and sequentially gives them to the identification module 113 via the buffer 112.

The identification module 113 identifies an applicable Security Association (SA) policy from the data of a packet. Then the identification module 113 adds a Security Association ID (SAID) indicating the applicable SA policy to the packet as an identification result, and gives the packet to the header processing module 115 via the buffer 114. The header processing module 115, which received the SAID, extracts a policy specified by the SAID from Security Association DataBase (SADB containing the specific details of policies). Then the header processing module 115 adds a tunnel header or an IPSEC ESP header according to the policy. Then the header processing module 115 extracts and adds encryption protocol information and encryption key information to be used by the cipher module 117, from the SADB to the packet, and gives the packet to the cipher module 117 via the buffer 116. The cipher module 117 encrypts the payload of the packet by using the encryption protocol and encryption key received from the header processing module 115. The packet is given to a packet transmission circuit (not illustrated) via the buffer 118. The packet transmission circuit outputs the encrypted packet received via the buffer 118, from the network transmission port 119 to the Internet 30.

On the other hand, the packet cipher unit 120 for decryption has a network reception port 121, a buffer 122, an identification module 123, a buffer 124, a header processing module 125, a buffer 126, an cipher module 127, a buffer 128, and an Ethernet transmission port 129, and is designed to decrypt and output encrypted packets received from the Internet 30 to the router 31.

The network reception port 121 is connected to the Internet 30 and is designed to give packets received via the Internet 30, to a packet reception circuit (not illustrated). The packet reception circuit gives the packets to the identification module 123 via the buffer 122. The decryption processing that is executed by the identification module 123, the buffer 124, the header processing module 125, the buffer 126, and the cipher module 127 is basically the same as the above encryption processing, except that different parameters are used in an identification process and the cipher module 127 performs a decryption process.

In the packet cipher unit 110 for encryption and the packet cipher unit 120 for decryption as described above, the identification module 113, 123, the header processing module 115, 125, and the cipher module 117, 127 operate independently. In addition, the buffer 114, 124 is provided between the identification module 113, 123 and the header processing module 115, 125, and the buffer 116, 126 is provided between the header processing module 115, 125 and the cipher module 117, 127. Therefore, when each module completes own process, it gives a processed packet to a next module via a buffer, thereby realizing pipeline processing.

Hereinafter, the detailed operation of each component of the packet cipher unit 110 will be described by way of example.

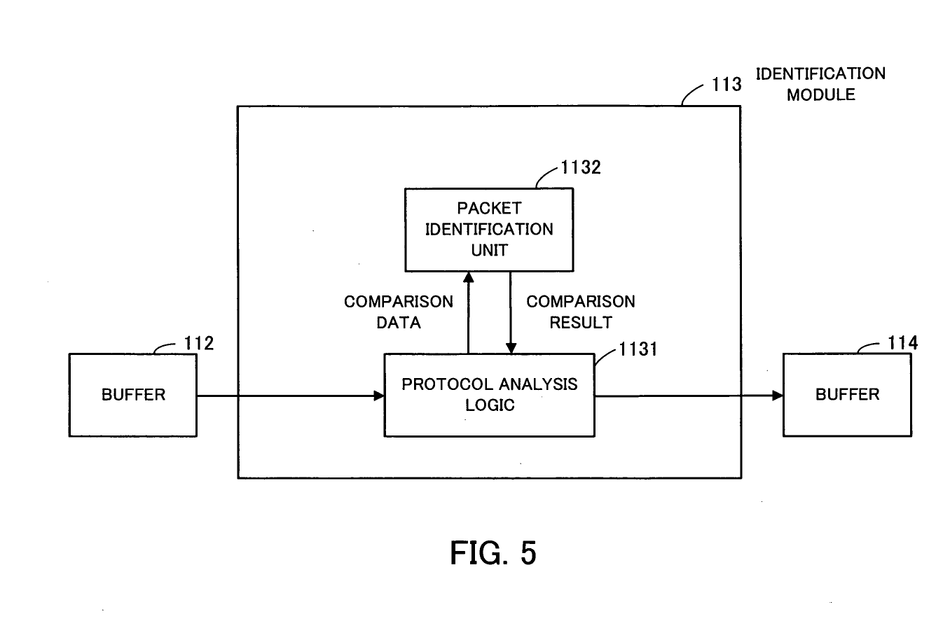

FIG. 5 shows an internal configuration of the identification module according to the embodiment of this invention.

The identification module 113 has a protocol analysis logic 1131 for analyzing a protocol and a packet identification unit 1132. In this connection, information is exchanged between the protocol analysis logic 1131 and the packet identification unit 1132 with a control logic that controls the packet identification unit 1132.

The protocol analysis logic 1131 analyzes a received packet to extract comparison data necessary for comparison in the packet identification process, such as an IP address included in the Internet Protocol (IP) header of the received packet and the port number of the Transmission Control Protocol (TCP) header. The extracted comparison data is outputted to the control logic of the packet identification unit 1132. The protocol analysis logic 1131 comprises a general CPU core such as Microprocessor without Interlocked Pipeline Stages (MIPS) or Acorn RISC Machine (ARM), a proprietary core optimized to analyze a protocol, a dedicated logic comprising a state machine for recognizing each field such as IP header, or the like. General CPU core has an advantage in that environment for software development has been already established. However, the general CPU core has disadvantages in that a gate scale is large and fast processing cannot be realized without increasing operation frequency because the general CPU core is not optimized to analyze a protocol or identify a packet and therefore overhead in internal processing is large. Dedicated logic has an advantage in that a gate scale is small and processing capacity per frequency can be largest. However, the dedicated logic is not flexible in processing operation, which is a considerable disadvantage. In addition, proprietary core has a disadvantage in that environment for software development has not been established. However, because the proprietary core is flexible in processing, can be optimized to obtain satisfied processing capacity at a low frequency, and can have a gate scale smaller than general CPU, the proprietary core is considered as the most balanced implementation method.

The packet identification unit 1132 has a reference table containing a plurality of reference unit data for each attribute, and is designed to obtain from the reference table unit data corresponding to the attribute of comparison data extracted by the protocol analysis logic 1131, and compares the unit data with the comparison data. Then the packet identification unit 1132 returns the comparison result to the protocol analysis logic 1131. Hereinafter, it is assumed that the packet identification unit 1132 has a configuration of a packet identification device disclosed in Japanese Patent Application No. 2004-567524 filed by the applicant of this application.

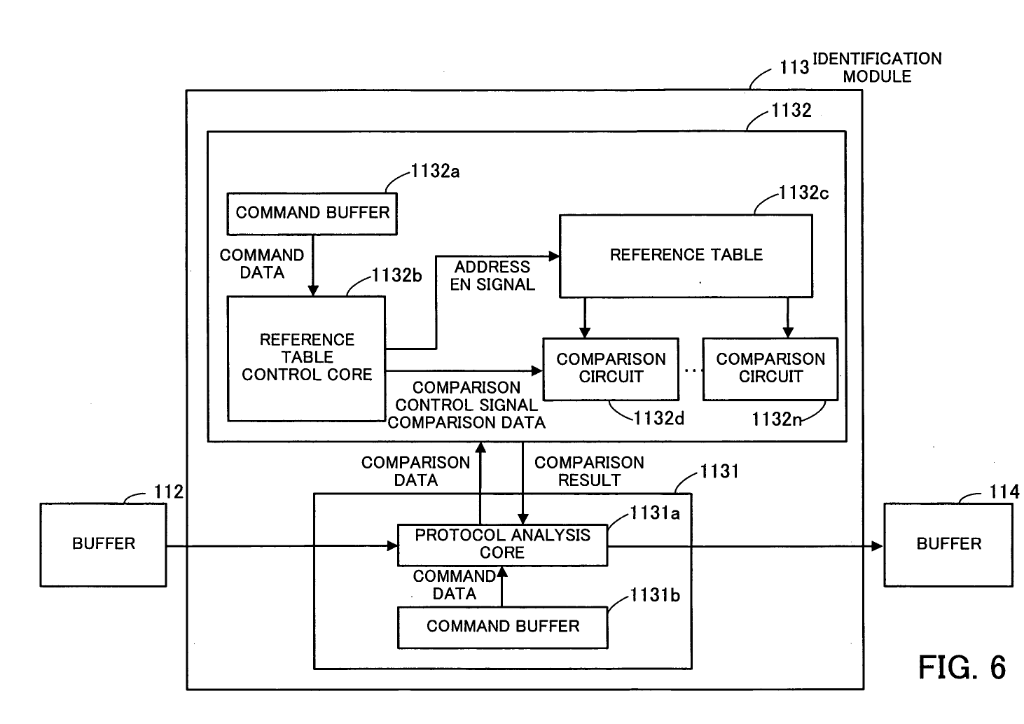

FIG. 6 shows an example implementation in which an identification module comprises optimized cores, according to the embodiment of this invention. In FIG. 6, the protocol analysis logic 1131 and the packet identification unit 1132 each comprises a core optimized to execute corresponding processing.

The protocol analysis logic 1131 composing the identification module 113 has an optimized protocol analysis core 1131a and a command buffer 1131b for storing command data that is executed by the protocol analysis core 1131a.

The protocol analysis core 1131a reads an inputted packet from the buffer 112 storing the packet, according to command data read from the command buffer 1131b, and copies the packet into the buffer 114 to be used by the header processing module 115. At this time, the protocol analysis core 1131a analyzes the protocol of the packet, extracts data necessary for comparison, and gives the data to the packet identification unit 1132. In addition, at the same time, the protocol analysis core 1131a analyzes the header of the packet to determine where to insert an IPSEC header, and so on. Then the protocol analysis core 1131a writes some of obtained information, such as a comparison result received from the packet identification unit 1132 and the analysis result of the header, in the buffer 114.

Similarly, the packet identification unit 1132 composing the identification module 113 has a command buffer 1132a, a reference table control core 1132b, a reference table 1132c, and comparison circuits 1132d, and 1132n.

The reference table control core 1132b operates according to command data stored in the command buffer 1132a. The reference table 1132c contains a plurality of reference unit data for each attribute. The comparison circuits 1132d, . . . , and 1132n each compares unit data extracted from the reference table 1132c with comparison data received from the protocol analysis logic 1131, and outputs the resultant. The reference table control core 1132b creates a final comparison result based on the comparison results of the comparison circuits 1132d, . . . , and 1132n, and outputs it to the protocol analysis logic 1131.

In the above packet identification unit 1132, the reference table control core 1132b recognizes the attribute of the comparison data obtained from the protocol analysis logic 1131, specifies an address corresponding to the recognized attribute in the reference table 1132c, as a readout address, and outputs the address together with an enable (EN) signal to the reference table 1132c. In addition, the reference table control core 1132b outputs the comparison data and a comparison control signal to the comparison circuits 1132d, . . . , and 1132n to make them perform a comparison process. The comparison circuits 1132d, . . . , and 1132n each compares the reference data extracted from the reference table 1132c with the comparison data, and outputs the comparison result. In the case where an SA of IPSEC is identified, for example, reference data including the IP addresses of terminal devices to be protected is contained in the reference table 1132c. The IP address of a packet to be transferred is inputted from the protocol analysis logic 1131 as comparison data. If matched reference data is found, the SAID registered in the matched reference data is outputted as a comparison result.

In this connection, the reference table control core 1132b is a core optimized to extract data from the reference table, and has functions for controlling a protocol analysis circuit, an address control circuit for controlling data to be extracted from the reference table, and comparison circuits. By using optimized cores as described above, implementation satisfying three requirements of flexibility, operation frequency, and gate scale can be realized.

Now, data to be written by the identification module 113 in the buffer 114 will be described. This data is given to the header processing module 115.

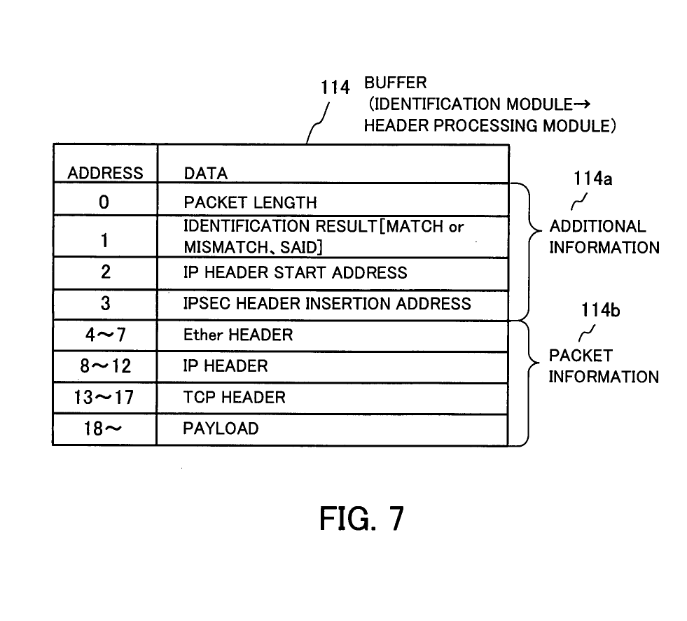

FIG. 7 shows an example structure of data to be given from the identification module to the header processing module, according to the embodiment of this invention.

In this example of FIG. 7, in the buffer 114, additional information 114a added by the identification module 113 and inputted packet information are written by the identification module 113.

The additional information 114a includes “packet length”, “identification result”, “IP header start address” and “IPSEC header insertion address”. In “packet length” of address 0, the length of packet up to payload is set. In “identification result” of address 1, a result (match or mismatch) of comparison with reference data by the identification module 113, SAID registered in matched reference data, and so on are set. “IP header start address” of address 2 indicates a start address of an IP header stored in the buffer 114, and “8” is set in this example. “IPSEC header insertion address” of address 3 is an address to which an IPSEC header is inserted in the buffer 114, and “13” is set in this example. “IP header start address” and “IPSEC header insertion address” are obtained by analyzing a header.

The packet information 114b contains a received packet as it is. Addresses 4 to 7 contain “Ether header”, addresses 8 to 12 contain “IP header”, and addresses 13 to 17 contain “TCP header”. These collectively correspond to the header of a packet. After address 18, “payload” is stored.

Now, the header processing module 115 will be described.

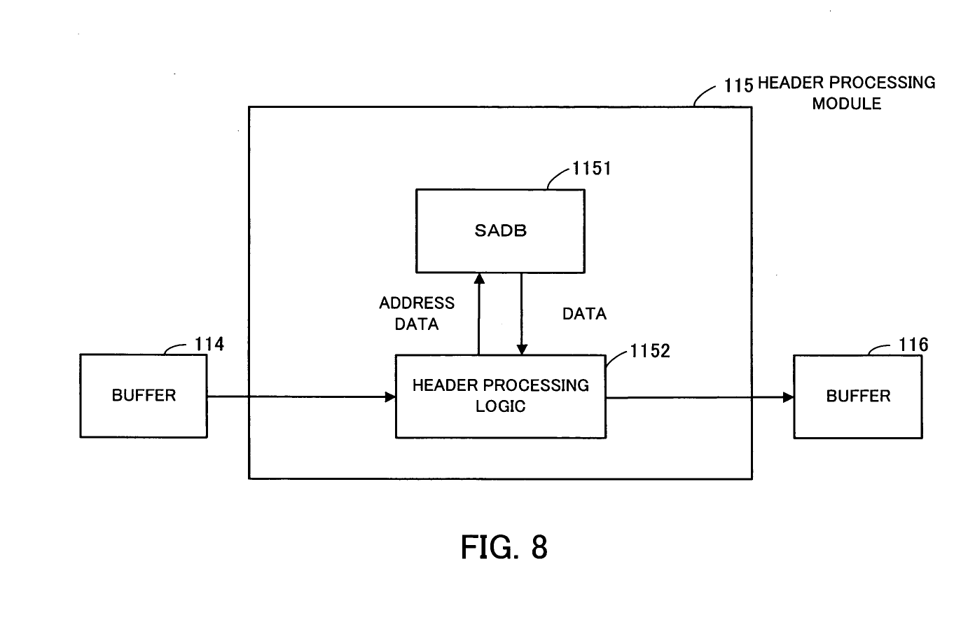

FIG. 8 shows an internal configuration of the header processing module according to the embodiment of this invention.

The header processing module 115 according to the embodiment of this invention has an SADB 1151 and a header processing logic 1152 for processing a header.

The SADB 1151 is a database showing details of policies, and contains information such as encryption algorithms, encryption keys, and specified IPSEC modes. In addition, by providing the header processing module 115 with a dedicated memory for storing the SADB 1151, overhead caused by memory access when data is extracted from the SADB 1151 can be reduced.

The header processing logic 1152 adds a tunnel header or an IPSEC header to a received packet according to an SA policy obtained from the SADB 1151. Similarly to each logic of the identification module 113, the header processing logic 1152 can comprise a general CPU core such as MIPS or ARM, a proprietary core optimized to analyze a protocol, or a dedicated logic. In this connection, similarly to the identification module 113, using an optimized core provides the most balanced implementation.

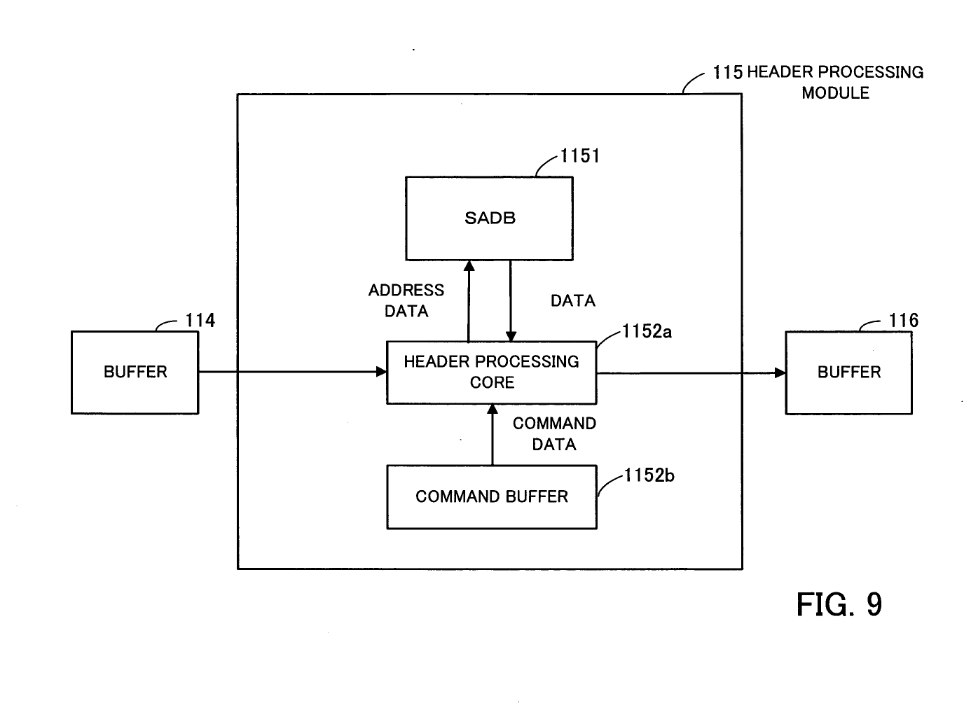

FIG. 9 shows an example of implementation in which the header processing module comprises an optimized core according to the embodiment of this invention.

The header processing logic 1152 has a header processing core 1152a and a command buffer 1152b. The command buffer 1152b contains command data for header processing. The header processing core 1152a processes a header according to command data extracted from the command buffer 1152b.

The header processing core 1152a reads additional information 114a set in the buffer 114 by the identification module 113, and extracts the details of a policy specified by the SAID from the SADB 1151. At this time, based on the SAID, for example, the header processing core 1152a obtains the address corresponding to the SAID in the SADB 1151 and specifies the address to the SADB 1151. Alternatively, the header processing core 1152 may specify ID data directly. From the SADB 1151, all parameters necessary for processing the packet can be extracted. The header processing core 1152a inserts a header according to the extracted policy while copying packet information from the buffer 114 to the buffer 116. In addition, if necessary, the header processing core 1152a rewrites the packet length field or a next header field of the IP header.

Now, data to be written by the header processing module 115 into the buffer 116 will be described. This data is given to the cipher module 117.

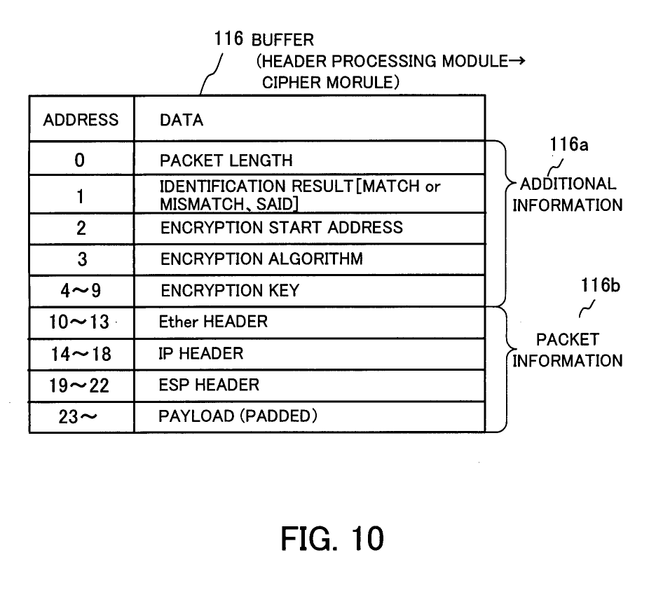

FIG. 10 shows an example structure of data to be given from the header processing module to the cipher module, according to the embodiment of this invention. FIG. 10 shows an example of applying IPSEC in a transport mode. The following explanation is about a part that is added or changed from the configuration of the buffer 114 shown in FIG. 7 by the header processing module 115.

In the additional information 116a, “encryption start address” of address 2 and “encryption algorithm” of address 3, and “encryption key” of addresses 4 to 9 are newly set. These information is set according to a policy read from the SADB 1151 based on an SAID. For example, the start address of payload (address 23 in this example) is set to “encryption start address”. In addition, an employed encryption technique extracted from the SADB 1151, for example, “3DES” is set to the “encryption algorithm”. “Encryption key” is a key for encryption, for example, a key of 6 words in the case of “3DES”, is set to “encryption key”.

The packet information 116b contains an IPSEC ESP header at a position (addresses 19 to 22) that is specified by the additional information 114a as an IPSEC header insertion address. Note that in payload from address 23, padding data is added.

Now, the cipher module 117 will be described.

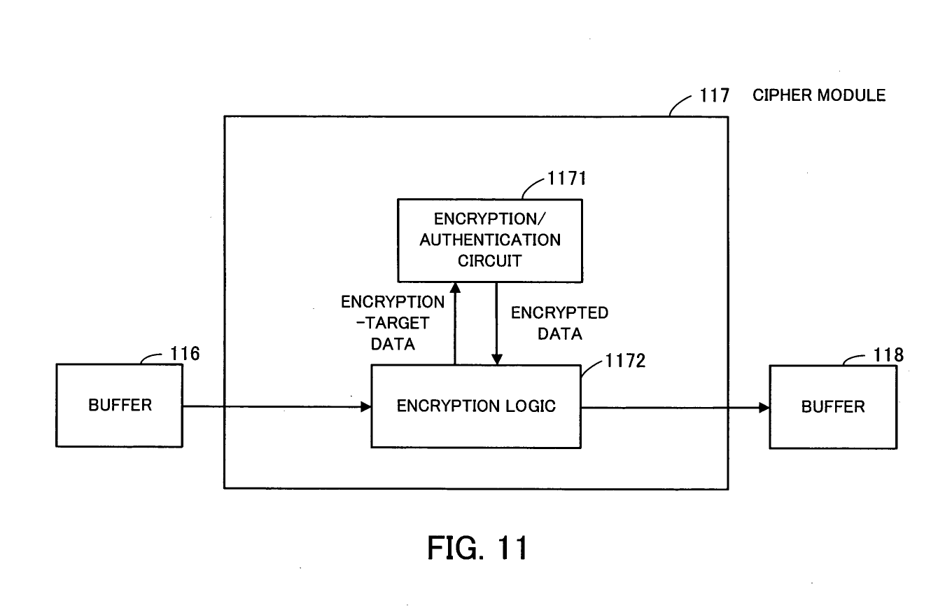

FIG. 11 shows an internal configuration of the cipher module according to the embodiment of this invention.

The cipher module 117 according to the embodiment of this invention has an encryption/authentication circuit 1171 and an encryption logic 1172 for controlling an encryption process.

The encryption/authentication circuit 1171 is a dedicated circuit to execute specified encryption algorithms fast, and is equivalent to a conventional encryption/authentication accelerator.

The encryption logic 1172 encrypts an encryption-target part of a packet, based on “encryption algorithm” and “encryption key” given from the header processing module 115 via the buffer 116. Similarly to each logic of the other modules, this encryption logic 1172 may comprise a general CPU core such as MIPS or ARM, or a proprietary core optimized to analyze a protocol, or a dedicated logic. However, using an optimized core provides the most balanced implementation because of the same reason as the identification module 113.

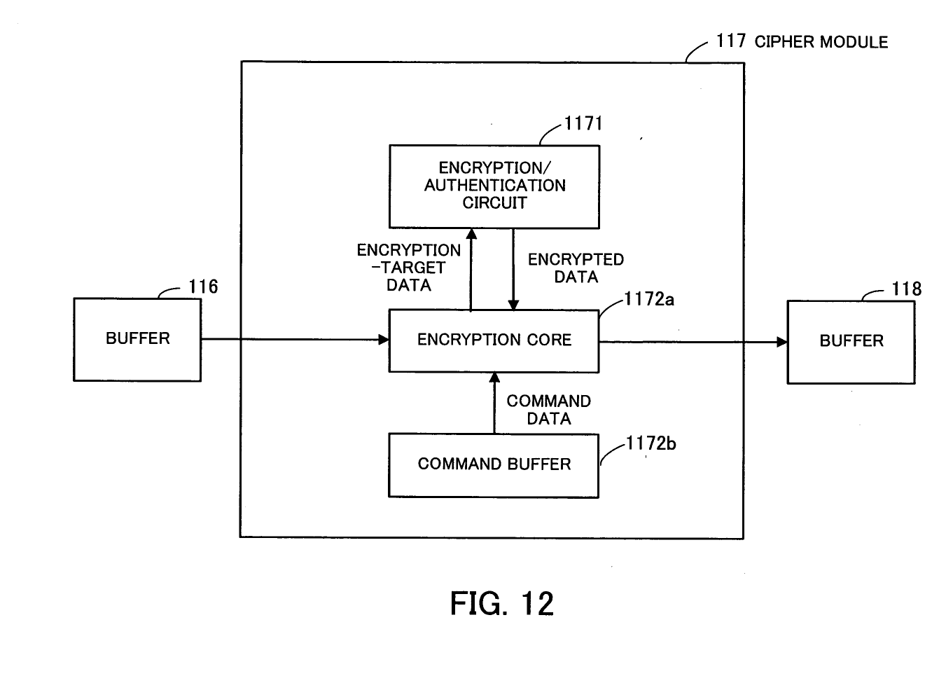

FIG. 12 shows an example implementation in which the cipher module comprises an optimized core, according to the embodiment of this invention.

The cipher module 117 has an encryption core 1172a and a command buffer 1172b. The command buffer 1172b contains command data for encryption, and the encryption core 1172a controls the encryption process according to command data read from the command buffer 1172b. In order to realize fast processing, it is important to operate the encryption/authentication circuit 1171 effectively, and a logic for this purpose is implemented in the encryption core 1172a.

The operation of the cipher module 117 will now be described. The encryption core 1172a reads the additional information 116a set by the header processing module 115 in the buffer 116, and obtains “encryption start address”, “encryption algorithm”, and “encryption key”. The encryption core 1172a copies a part to be not encrypted, out of the packet information 116b stored in the buffer 116, into the buffer 118. At this time, a part before “payload” specified by “encryption start address” (from Ether header to ESP header) is copied. The following encryption-target part is given to the encryption/authentication circuit 1171 for encryption. The data encrypted by the encryption/authentication circuit 1171 is written in the buffer 118.

The packet data written in the buffer 118 has a final format and is output to the Internet 30 via the transmission circuit as it is.

As described above, according to the embodiment of this invention, optimized cores are implemented, and the identification module 113, the header processing module 115, and the cipher module 117, which can realize fast processing, operate independently to process packets in a pipeline manner. Thereby, even if packet length is short, overhead in processes, especially, the identification process and the header processing, which are conventionally executed by a single CPU, do not become bottleneck, and therefore fast encryption processing can be realized.

Similarly, fast decryption processing can be realized by executing an identification step, a header processing step, and a decryption step independently.

By the way, according to the above embodiment, the buffers 114 and 116 are provided between the identification module 113, the header processing module 115, and the cipher module 117. Alternatively, one buffer can be prepared and shared.

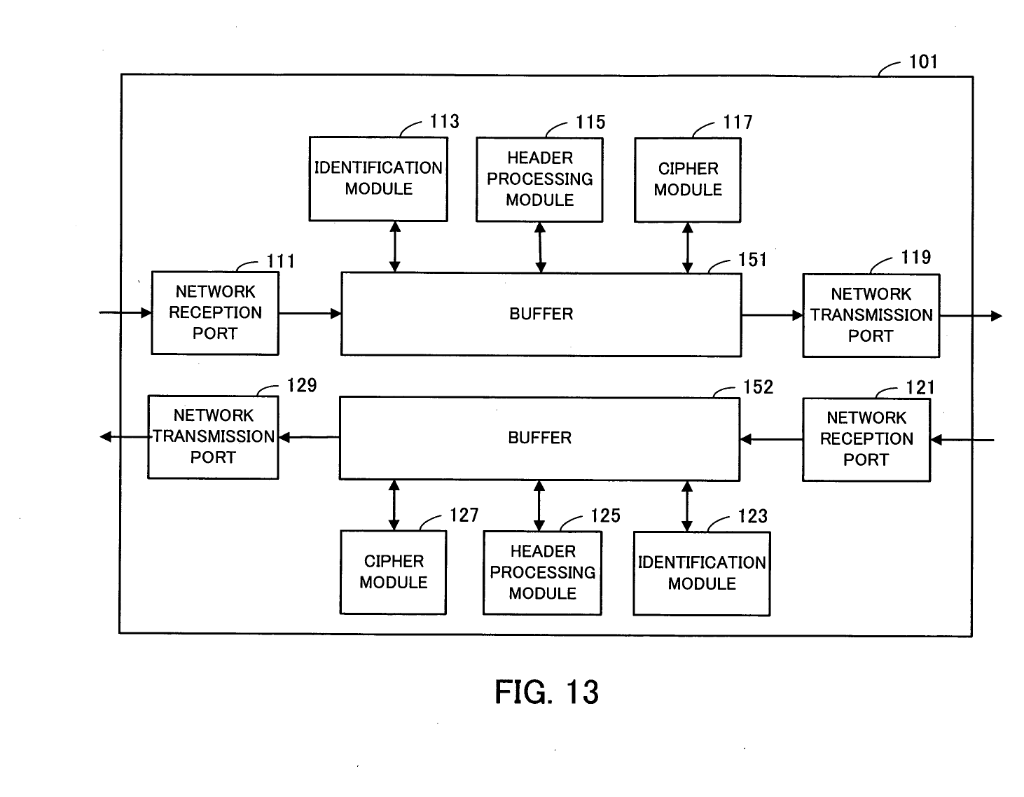

FIG. 13 shows an example configuration of a VPN device according to the second embodiment of this invention.

The same components have the same reference numerals as FIG. 4 and their description will not be repeated.

The VPN device 101 according to the second embodiment has a buffer 151 which is shared by the modules of a packet cipher unit for encryption, and a buffer 152 which is shared by the modules of a packet cipher unit for decryption.

In the packet cipher processor for encryption, a reception circuit first stores a packet received via a network reception port 111, in the buffer 151. Then an identification module 113, a header processing module 115, and a cipher module 117 sequentially execute processing of a target packet stored in the buffer 151, including addition of additional information and packet conversion in the buffer 151, and outputs the packet in transmittable format from a network transmission port 119. In the case where a next packet is inputted, this packet is stored in an unused region and the same processing is executed. Therefore, by using the shared buffer 151, the steps are executed in a pipeline manner.

Similarly, for decryption, an identification module 123, a header processing module 125, and a cipher module 127 use the shared buffer 152 to perform the pipeline processing.

It should be noted that in the case of using a shared buffer, there are problems in that complicated access control is required because several modules access the buffer at the same time. In addition, a bandwidth of a memory is difficult to secure.

The above describes the cipher processing of a VPN device by way of example, but this invention is not limited to this. For example, not only processing of IP packets, but also processing including a data identification process, header processing, and a cipher process is all included.

Further, the packet cipher processing has complementary processes, other than encryption, including addition of Virtual Local Area Network (VLAN) tag or user-defined header, error check of packet, fragment process, and/or record of statistical data. Such modification that one or a combination of the above three modules or a combination of the modules and other modules may perform the above processes should be regarded as falling within the scope of the invention. Furthermore, as described earlier, the processing order of the header processing module and the cipher module is not fixed but can be switched. This also should be regarded as falling within the scope of the invention. For example, such modification that a module takes some of processes of another module, for instance, the cipher module adds an ESP header, should be regarded as falling within the scope of the invention.

The packet cipher processing of this invention is realized by processing units that independently operate for a packet identification process, a header conversion process, and a cipher process. Thereby three processing steps (identification step, header processing step, and cipher/authentication step) in the packet cipher processing can be realized in a pipeline manner, thus realizing faster packet cipher processing.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A packet cipher processor for performing prescribed cipher processing on a received packet and outputting the received packet, comprising:
packet identification means for analyzing a received target packet to be processed, to identify a policy applicable to the target packet, and creating policy information of the policy;
header processing means for converting according to the policy information a header of the target packet, which has been subjected to an identification process by the packet identification means; and
cipher means for performing a prescribed cipher process including at least one of encryption, decryption, and authentication, according to the policy information, on the target packet and outputting the target packet, wherein the packet identification means, the header processing means and the cipher means operate independently.

2. The packet cipher processor according to claim 1, further comprising a packet buffer for temporarily storing transition information including the target packet and the policy information that are communicated between the packet identification means, the header processing means, and the cipher means, wherein:
the packet identification means stores the target packet, which has been subjected to the identification process, and the transition information in the packet buffer, and passes processing of the target packet to one means of the header processing means and the cipher means, which operates following the packet identification means, and
the one means of the header processing means and the cipher means stores the target packet, which has been processed, and the transition information in the packet buffer, and passes the processing of the target packet to the other means of the cipher means and the header processing means, which operates following the one means.

3. The packet cipher processor according to claim 2, where the packet buffer includes:
a first packet buffer for giving the target packet and the transition information from the packet identification means to the one means of the header processing means and the cipher means, which operates following the packet identification means; and
a second packet buffer for giving the target packet and the transition information from the one means of the header processing means and the cipher means, which operates following the packet identification means, to the other means of the cipher means and the header processing means, which operates following the one means.

4. The packet cipher processor according to claim 2, wherein:
the packet buffer comprises a single buffer to be used when the packet identification means gives the target packet and the transition information to the one means of the header processing means and the cipher means, which operates following the packet identification means, and to be used when the one means of the header processing means and the cipher means, which operates following the packet identification means, gives the target packet and the transition information to the other means of the cipher means and the header processing means, which operates following the one means; and
the packet identification means, the header processing means, and the cipher means access the packet buffer controlled by access control.

5. The packet cipher processor according to claim 1, wherein, when analyzing the target packet, the packet identification means analyzes a header of the target packet, creates header analysis information including an insertion position and conversion position of header information, and gives the header analysis information to the header processing means.

6. A packet cipher method for performing prescribed cipher processing on a received packet and outputting the packet, comprising:
a packet identification step of analyzing a received target packet to be processed, to identify a policy applicable to the target packet, and creating policy information of the policy;
a header processing step of converting according to the policy information a header of the target packet, which has been processed at the packet identification step; and
a cipher step of performing a prescribed cipher process including at least one of encryption, decryption, and authentication, according to the policy information, on the target packet and outputting the target packet, wherein the packet identification step, the header processing step and the cipher step are executed independently.
